(19) United States
(12) Patent Application Publication
(10) Pub. No.: US 2006/0087240 A1
(43) Pub. Date: Apr. 27, 2006

(54) Light generating device, method of manufacturing the same, backlight assembly having the same and display device having the same

(76) Inventors: Seok-Hyun Nam, Seoul (KR); Don-Chan Cho, Seongnam-si (KR); Hyun-Jin Kim, Seoul (KR)

Correspondence Address: CANTOR COLBURN, LLP, 55 GRIFFIN ROAD SOUTH, BLOOMFIELD, CT, 06002, US

(21) Appl. No.: 11/189,290

(22) Filed: Jul. 26, 2005

(30) Foreign Application Priority Data
Oct. 21, 2004 (KR) 2004-84525

(51) Int. Cl. H01J 65/00

(52) U.S. Cl. 313/607; 313/594

(57) ABSTRACT

A light generating device includes a body, electrodes, and an adhesive member. Visible light is emitted from the body. The electrodes are disposed on an outer surface of the body. The adhesive member includes a first conductive adhesive layer and a second conductive adhesive layer. The first conductive adhesive layer is formed between the body and each of the electrodes and has a first conductive paste of a first viscosity. The second conductive adhesive layer is formed between each of the electrodes and the first conductive adhesive layer and has a second conductive paste of a second viscosity. The second viscosity is smaller than the first viscosity. The light generating device including the conductive adhesive member having double layers increases light generating efficiency and improves display quality of an image displayed from a display device. A backlight assembly and a display device incorporating the light generating device, and methods for manufacturing the light generating device are further described.

This application claims priority to Korean Patent Application No. 2004-84525, filed on Oct. 21, 2004 and all the benefits accruing therefrom under 35 U.S.C. §119, and the contents of which in its entirety are herein incorporated by reference.

### BACKGROUND OF THE INVENTION

1. Field of the Invention

The present invention relates to a light generating device, a method of manufacturing the light generating device, a backlight assembly having the light generating device, and a display device having the light generating device. More particularly, the present invention relates to a light generating device capable of improving optical characteristics, a method of manufacturing the light generating device, a backlight assembly having the light generating device, and a display device having the light generating device.

2. Description of the Related Art

Generally, a liquid crystal display (“LCD”) device displays an image using electrical and optical characteristics of liquid crystal.

The LCD device receives light from a backlight assembly to display an image. The backlight assembly of the LCD device includes a cold cathode fluorescent lamp (“CCFL”) having a lamp tube and a pair of electrodes disposed in the lamp tube.

The CCFL has demerits, for example, hardness of driving the CCFLs electrically connected in parallel with each other.

Therefore, in order to drive lamps that are electrically connected in parallel with each other, an external electrode fluorescent lamp (“EEFL”) has been developed. However, the EEFL still has a demerit such as a bad connection between a lamp body and an external electrode. In particular, a void generated between the lamp body and the external electrode induces deterioration of optical characteristics.

### BRIEF SUMMARY OF THE INVENTION

Therefore, regarding above-mentioned disadvantages of the related arts, the present invention provides a light generating device capable of improving optical characteristics.

The present invention also provides methods of manufacturing the above-mentioned light generating device.

The present invention also provides a backlight assembly including the above-mentioned light generating device.

The present invention still also provides a display device including the above-mentioned backlight assembly.

A light generating device in accordance with one exemplary embodiment of the present invention includes a body, electrodes, and an adhesive member. The body generates visible light. The electrodes are disposed on the body to apply a power to the body. The adhesive member includes a first conductive adhesive layer and a second conductive adhesive layer. The first conductive adhesive layer is formed between the body and each of the electrodes and has a first conductive paste of a first viscosity. The second conductive adhesive layer is formed between each of the electrodes and the first conductive adhesive layer and has a second conductive paste of a second viscosity. The second viscosity is different from the first viscosity, and may be smaller than the first viscosity. The first and second viscosities may preferably be in a range of about 20,000 cps to about 30,000 cps and in a range of about 10,000 cps to about 20,000 cps, respectively.

One exemplary method of manufacturing the light generating device is provided as follows. A body converting invisible light into visible light is formed. A first conductive adhesive layer having a first conductive paste of a first viscosity on at least one end portion of the body is formed. A second conductive adhesive layer having a second conductive paste of a second viscosity on the first conductive adhesive layer is formed. Here, the second viscosity is different from the first viscosity, such as smaller than the first viscosity. Electrodes applying power to the body on the second conductive adhesive layer are formed.

Another exemplary method of manufacturing the light generating device is provided as follows. A body converting invisible light into visible light is formed. A first conductive adhesive layer having a first conductive paste of a first viscosity on at least one end portion of the body is formed. A second conductive adhesive layer having a second conductive paste of a second viscosity on an inner surface of an electrode is formed. The second viscosity is different from the first viscosity, and may be smaller than the first viscosity. The electrode is coupled with the body so that the second conductive adhesive layer is disposed on the first conductive adhesive layer.

An exemplary embodiment of a backlight assembly includes a light generating device, a power supplying member, and a receiving container. The light generating device includes a lamp body, electrodes, and an adhesive member. The lamp body converts invisible light into visible light. The electrodes are disposed on the lamp body to apply power to the lamp body. The adhesive member includes a first conductive adhesive layer and a second conductive adhesive layer. The first conductive adhesive layer is formed between the body and each of the electrodes, and has a first conductive paste of a first viscosity. The second conductive adhesive layer is formed between the first conductive adhesive layer and each of the electrodes, and has a second conductive paste of a second viscosity. The second viscosity is different from the first viscosity, such as smaller than the first viscosity. The power supplying member supplies the electrodes with power. The receiving container includes a bottom plate and a sidewall disposed on the bottom plate to form a receiving space receiving the light generating device and the power supplying member.

An exemplary embodiment of a display device includes a light generating device, a power supplying member, a receiving container, and a display panel. The light generating device includes a lamp body, electrodes, and an adhesive member. The lamp body converts invisible light into visible light. The electrodes are disposed on the lamp body to apply power to the lamp body. The adhesive member includes a first conductive adhesive layer and a second conductive adhesive layer. The first conductive adhesive layer is formed between the body and each of the electrodes, and has a first conductive paste of a first viscosity. The second conductive adhesive layer is formed between the first conductive adhesive layer and each of the electrodes, and has a second conductive paste of a second viscosity. The second viscosity is different from the first viscosity, such as smaller than the first viscosity. The power supplying member supplies the electrodes with power. The receiving container includes a bottom plate and a sidewall disposed on the bottom plate to form a receiving space receiving the light generating device and the power supplying member. The display panel is disposed over the receiving container to convert the visible light into light having an image information.

Thus, the light generating device generating a light to display an image has low power consumption and an advantage of being driven in parallel. The light generating device includes a cup-shaped electrode coupled with an outer surface of the body. The conductive adhesive layer is formed between the electrode and the body. During coupling the electrode with the body or firing the body coupled the electrode therewith, a solvent of the conductive adhesive layer may be volatilized, so that a void may be generated. However, the light generating device includes at least two conductive adhesive layers of a different viscosity from each other, thereby preventing the generation of the void in the conductive adhesive layers.

### BRIEF DESCRIPTION OF THE DRAWINGS

The above and other features and advantage points of the present invention will become more apparent by describing in detailed exemplary embodiments thereof with reference to the accompanying drawings, in which:

FIG. 1 is a cross-sectional view illustrating an exemplary embodiment of a light generating device;

FIG. 2 is an enlarged view of portion ‘A’ shown in FIG. 1;

FIG. 3 is a cross-sectional view illustrating an exemplary first conductive adhesive layer and an exemplary second conductive adhesive layer in FIG. 2;

FIG. 4 is a cross-sectional view illustrating a body formed by an exemplary embodiment of a method of manufacturing a light generating device;

FIG. 5 is a cross-sectional view illustrating the exemplary body in FIG. 4 and an exemplary first conductive adhesive layer formed thereon;

FIG. 6 is a cross-sectional view illustrating the body including the first exemplary conductive adhesive layer formed thereon in FIG. 5 and an exemplary second conductive adhesive layer formed thereon;

FIG. 7 is a cross-sectional view illustrating the body including the first and second exemplary conductive adhesive layers successively formed thereon in FIG. 6 and an exemplary electrode coupled therewith;

FIG. 8 is a cross-sectional view illustrating a body and a first conductive adhesive layer formed by another exemplary embodiment of a method of manufacturing a light generating device;

FIG. 9 is a cross-sectional view illustrating an exemplary electrode and an exemplary second conductive adhesive layer formed by another exemplary embodiment of a method of manufacturing a light generating device;

FIG. 10 is a cross-sectional view illustrating a coupling of the body with the electrode shown in FIGS. 8 and 9;

FIG. 11 is a cross-sectional view illustrating an exemplary embodiment of a backlight assembly;

FIG. 12 is a cross-sectional view illustrating an exemplary light generating device in FIG. 11;

FIG. 13 is a cross-sectional view illustrating an exemplary embodiment of a display device;

FIG. 14 is a plan view illustrating an exemplary thin film transistor substrate shown in FIG. 13; and

FIG. 15 is a cross-sectional view illustrating an exemplary color filter substrate shown in FIG. 13.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like reference numerals refer to similar or identical elements throughout. In the drawings, the thickness of layers, films, and regions are exaggerated for clarity. It will be understood that when an element such as a layer, film, region, or substrate is referred to as being “on” another element, it can be directly on the other element or intervening elements may also be present.

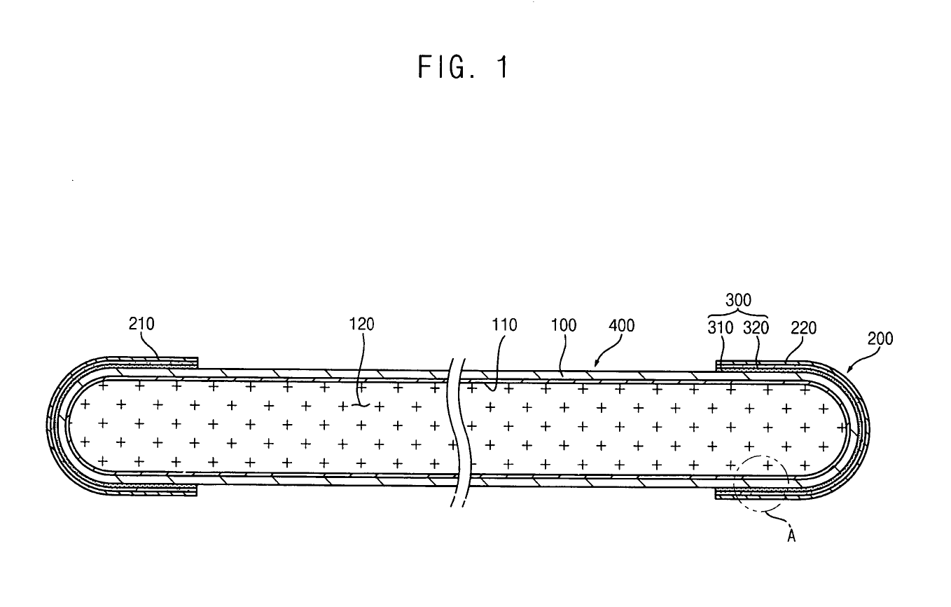

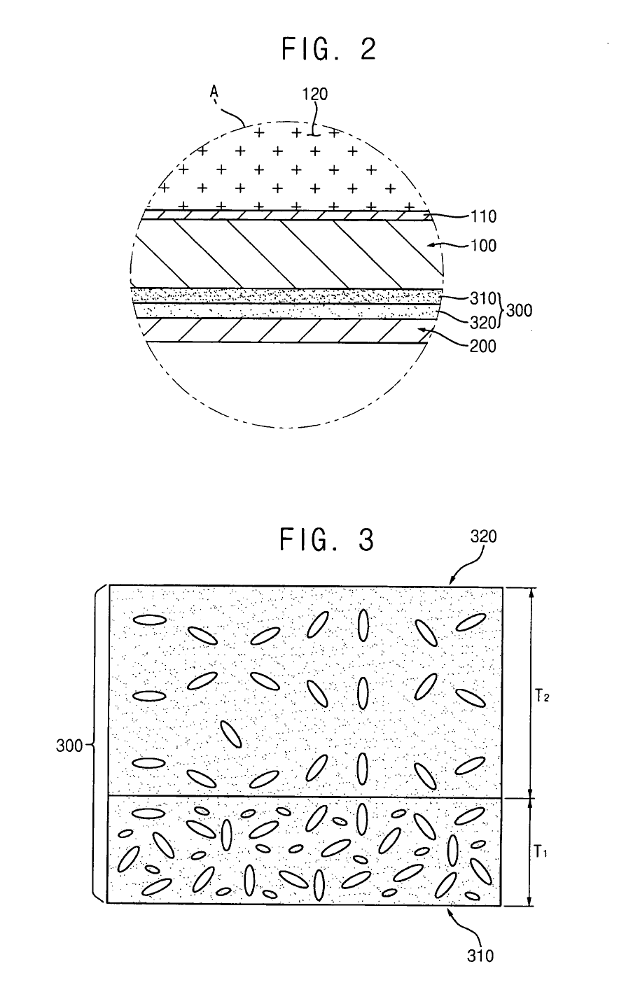

FIG. 1 is a cross-sectional view illustrating an exemplary embodiment of a light generating device. FIG. 2 is an enlarged view of portion ‘A’ shown in FIG. 1.

Referring to FIGS. 1 and 2, a light generating device 400 includes a body 100, an electrode part 200, and an adhesive member 300.

The body 100, for example, has a cylindrical shape along its longitudinal axis, with a circular cross-section taken along a plane intersecting the longitudinal axis perpendicularly. The body 100 further has rounded first and second end portions each having a hemispherical shape. The body 100 includes a material having high optical transmissivity. The body 100, by example only, includes glass, although other materials having similar characteristics would be within the scope of these embodiments. Although a linear shape is illustrated for the body 100, the body 100 may have various profiles such as a curved shape, a U-shape, a C-shape, an L-shape, etc. The body 100 includes a fluorescent layer 110 and a discharge gas 120 to generate visible light.

The fluorescent layer 110 is disposed on an inner surface of the body 100. The fluorescent layer 110 converts invisible light generated by the discharge gas 120 in the body 100 into the visible light. The fluorescent layer 110, for example, includes red fluorescent material, green fluorescent material, and blue fluorescent material. The red, green, and blue fluorescent materials convert the invisible light into red light, green light, and blue light, respectively. Thus, white light similar to sunlight may be emitted from the fluorescent layer 110.

The discharge gas 120 is injected into an interior of the body 100 to generate the invisible light such as ultra-violet (“UV”) light. The discharge gas 120, for example, includes mercury (Hg), argon (Ar), neon (Ne), xenon (Xe), krypton (Kr), etc. Mercury generates UV light, and argon, neon, xenon, krypton, etc. generate plasma in the body 100.

The electrode part 200 includes a first electrode 210 and a second electrode 220. The first and second electrodes 210 and 220 are spaced apart from each other on an outer surface of the body 100. For example, first and second electrodes 210 and 220 are positioned on first and second end portions of the body 100. When the first and second electrodes 210 and 220 are disposed on the outer surface of the body 100, power consumption of the body 100 may be decreased and at least two light generating devices 400 may be electrically connected substantially parallel with each other.

A discharging voltage, such as from a power supplying member as will be further described below, is applied to the first and second electrodes 210 and 220. The discharging voltage is sufficient enough to generate light from the discharge gas 120 in the body 100.

The first and second electrodes 210 and 220 may include a metallic material having good electrical conductivity, for example, copper (Cu), copper-alloy, aluminum (Al), aluminum-alloy, etc. Alternatively, the first and second electrodes 210 and 220 may include a transparent conductive material such as indium zinc oxide (“IZO”), indium tin oxide (“ITO”) and amorphous indium tin oxide (“a-ITO”).

In the illustrated embodiment, each of the first and second electrodes 210 and 220 has a rounded cup shape. The first and second electrodes 210 and 220 are coupled with both end portions of the body 100, respectively.

The adhesive member 300 is disposed between each of the first and second electrodes 210 and 220, and end portions of the body 100. The adhesive member 300 includes a first conductive adhesive layer 310 and a second conductive adhesive layer 320. In other words, the adhesive member 300 has a multiple-layered structure. The first adhesive layer 310 may be placed adjacent the exterior surface of the body 100 and the second adhesive layer 320 may be positioned between the first adhesive layer 310 and the electrode part 200.

The first conductive adhesive layer 310 includes a first conductive paste having a first viscosity. The first conductive paste includes a conductive material, an adhesive, and a solvent. Preferably, the first viscosity is in a range of about 20,000 cps (centipoises) to about 30,000 cps. More preferably, the first viscosity is in a range of about 24,000 cps to about 26,000 cps. While specific viscosity ranges are described, it should be understood that viscosities outside of these ranges would also be within the scope of these embodiments.

The conductive material of the first conductive paste, for example, includes metallic particles. The particles may include silver (Ag) particles. Alternatively, the conductive material of the first conductive paste may include gold (Au), copper (Cu), aluminum (Al), etc. having good electrical conductivity.

The adhesive of the first conductive paste, for example, includes an epoxy resin. Alternatively, the adhesive of the first conductive paste may include various synthetic resins.

FIG. 3 is a cross-sectional view illustrating an exemplary first conductive adhesive layer 310 and an exemplary second conductive adhesive layer 320 in FIG. 2.

Referring to FIG. 3, the second conductive adhesive layer 320 includes a second conductive paste having a second viscosity that is different from, and preferably smaller than, the first viscosity of the first conductive paste of the first conductive adhesive layer 310. The second conductive paste includes a conductive material, an adhesive, and a solvent. Preferably, the second viscosity is in a range of about 10,000 cps to about 20,000 cps. More preferably, the second viscosity is in a range of about 14,000 cps to about 16,000 cps. While specific viscosity ranges are described, it should be understood that viscosities outside of these ranges would also be within the scope of these embodiments.

The conductive material of the second conductive paste, for example, includes metallic particles. The particles include, for example, silver (Ag) particles. Alternatively, the conductive material of the second conductive paste may include gold (Au), copper (Cu), aluminum (Al), etc. having good electrical conductivity.

The adhesive of the second conductive paste, for example, includes an epoxy resin. Alternatively, the adhesive of the second conductive paste may include various synthetic resins.

In this embodiment, the first viscosity of the first conductive adhesive layer 310 is determined, for example, by weight percent of the solvent among the conductive material, the adhesive and the solvent constituting the first conductive paste.

Also in this embodiment, the second viscosity of the second conductive adhesive layer 320 is determined, for example, by weight percent of the solvent among the conductive material, the adhesive and the solvent constituting the second conductive paste.

The weight percent of the solvent of the second conductive adhesive layer 320 is greater than the weight percent of the solvent of the first conductive adhesive layer 310. Thus, the second viscosity of the second conductive adhesive layer 320 is smaller than the first viscosity of the first conductive adhesive layer 310.

Since the weight percent of the solvent of the first conductive adhesive layer 310 is lower than the weight percent of the solvent of the second conductive adhesive layer 320, a first thickness T1 of the first conductive adhesive layer 310 is thinner than a second thickness T2 of the second conductive adhesive layer 320.

The electrode part 200 may include an opening. Gas generated when the solvents of the first and second conductive adhesive layers 310 and 320 are volatilized, that is, caused to pass off in the form of a vapor, is exhausted through the opening.

As described above, the first conductive adhesive layer 310 having the first viscosity is formed on the surface of the body 100 generating the visible light, and then the second conductive adhesive layer 320 having the second viscosity that is smaller than the first viscosity is formed on the first conductive adhesive layer 310. The second conductive adhesive layer 320 of the adhesive member 300 prevents the first conductive adhesive layer 310 from being scratched to induce a void that may be generated when the electrode part 200 is coupled with the adhesive member 300, thereby improving optical characteristics of the visible light emitted from the light generating device 400.

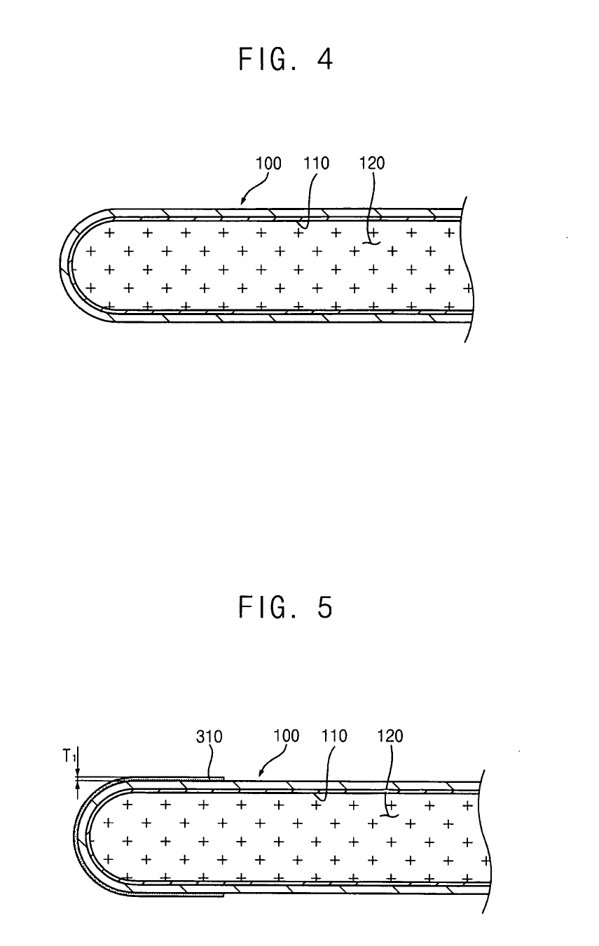

FIG. 4 is a cross-sectional view illustrating a body formed by an exemplary embodiment of a method of manufacturing a light generating device.

Referring to FIG. 4, the body 100 is firstly formed for manufacturing the light generating device 400. The body 100 may be formed in a tubular shape. The body 100, for example, includes glass having high optical transmissivity.

The fluorescent layer 110 converting invisible light into visible light is formed on an inner surface of the body 100. The discharge gas 120 generating invisible light is injected into an interior of the body 100.

FIG. 5 is a cross-sectional view illustrating the body 100 in FIG. 4 and a first conductive adhesive layer 310 formed thereon.

Referring to FIG. 5, the first conductive adhesive layer 310 is formed on an outer surface of the body 100. Although only one end portion is illustrated in FIG. 5, the first conductive adhesive layer 310, for example, is disposed on each end portion of the body 100.

As previously described, the first conductive adhesive layer 310 includes a first conductive paste having a first viscosity. Preferably, the first viscosity is in a range of about 20,000 cps to about 30,000 cps. More preferably, the first viscosity is in a range of about 24,000 cps to about 26,000 cps. The first conductive paste is a mixture including a conductive material, an adhesive, a solvent, etc. The conductive material may include conductive particles such as silver particles. The first conductive paste is coated on the outer surface of the body 100. The first conductive adhesive layer 310 has a first thickness T1 in this embodiment.

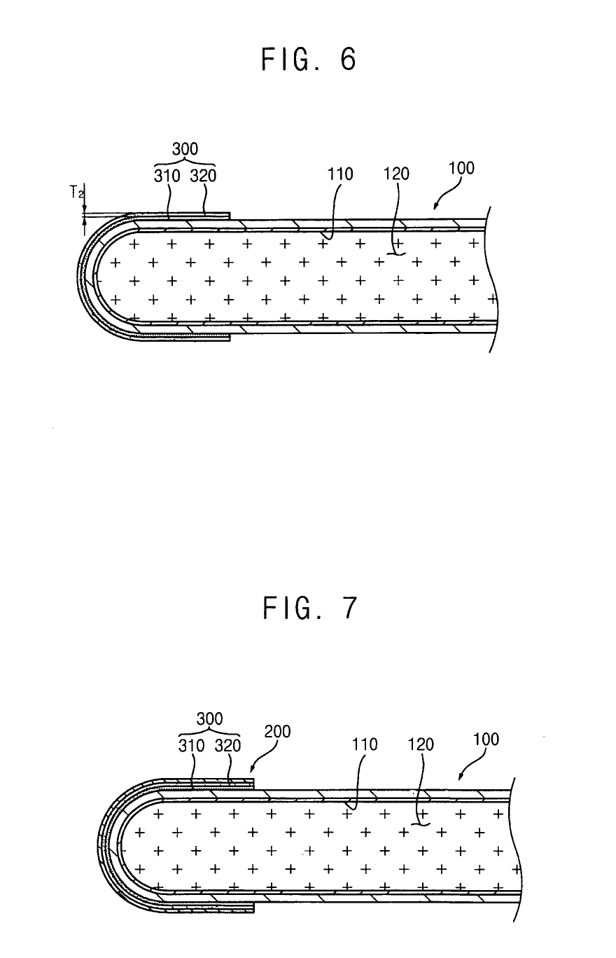

FIG. 6 is a cross-sectional view illustrating the body 100 including the first conductive adhesive layer 310 formed thereon in FIG. 5 and a second conductive adhesive layer 320 formed thereon.

Referring to FIG. 6, the second conductive adhesive layer 320 is formed on the first conductive adhesive layer 310. As previously described, the second conductive adhesive layer 320 includes a second conductive paste having a second viscosity. Preferably, the second viscosity is in a range of about 10,000 cps to about 20,000 cps. More preferably, the second viscosity is in a range of about 14,000 cps to about 16,000 cps. The second conductive paste is a mixture including a conductive material, an adhesive, a solvent, etc. The conductive material may include conductive particles such as, but not limited to, silver particles. The second conductive paste is coated on the first conductive adhesive layer 310. The second conductive adhesive layer 320 has a second thickness T2 thicker than the first thickness T1 of the first conductive adhesive layer 310 in this embodiment.

When the second conductive adhesive layer 320 having the second viscosity that is smaller than the first viscosity is formed on the first conductive adhesive layer 310 having the first viscosity, a boundary surface is formed between the first and second conductive adhesive layers 310 and 320.

FIG. 7 is a cross-sectional view illustrating the body 100 including the first and second conductive adhesive layers 310, 320 successively formed thereon in FIG. 6 and an electrode 200 coupled therewith.

Referring to FIG. 7, the electrode part 200 having a cup shape, such as a rounded cup shape, is coupled with the body 100 including the first and second conductive adhesive layers 310, 320 successively formed thereon. The electrode part 200 may slide onto the second conductive adhesive layer 320 having the second viscosity, and then the electrode part 200 is disposed over the body 100. Other methods for disposing the electrode part 200 over the body 100, other than sliding, are within the scope of these embodiments.

The body 100 including the electrode part 200 coupled therewith is heated. Thus, the solvents of the first and second conductive adhesive layers 310 and 320 are volatilized, so that the electrode part 200 and the body 100 are electrically coupled by the first and second conductive adhesive layers 310 and 320.

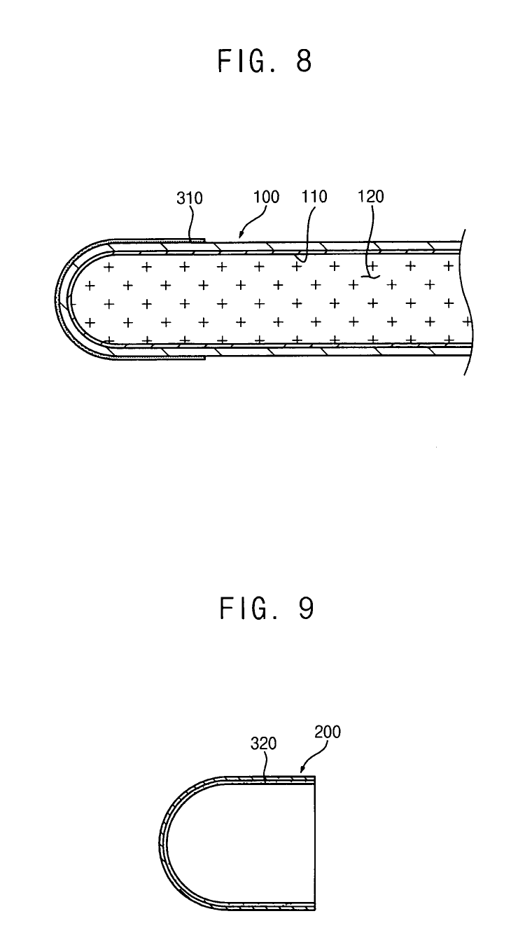

FIG. 8 is a cross-sectional view illustrating a body and a first conductive adhesive layer formed by an exemplary embodiment of a method of manufacturing a light generating device.

Referring to FIG. 8, the body 100 is firstly formed for manufacturing the light generating device 400. The body 100 may be formed in a tubular shape as previously described. The body 100, for example, includes glass having high optical transmissivity although other materials with similar properties are within the scope of these embodiments.

The fluorescent layer 110 converting invisible light into visible light is formed on an inner surface of the body 100. The discharge gas 120 generating the invisible light is injected into the body 100.

As previously described, the first conductive adhesive layer 310 is formed on an outer surface of the body 100. The first conductive adhesive layer 310, for example, is disposed on end portions of the body 100.

The first conductive adhesive layer 310 includes a first conductive paste having a first viscosity. Preferably, the first viscosity is in a range of about 20,000 cps to about 30,000 cps. More preferably, the first viscosity is in a range of about 24,000 cps to about 26,000 cps. The first conductive paste is a mixture including a conductive material, an adhesive, a solvent, etc. The conductive material may include conductive particles such as silver particles. The first conductive paste is coated on the outer surface of the body 100. The first conductive paste has a first thickness T1 in this embodiment.

FIG. 9 is a cross-sectional view illustrating an exemplary electrode 200 and an exemplary second conductive adhesive layer 320 formed by another exemplary embodiment of a method of manufacturing a light generating device.

Referring to FIG. 9, the second conductive adhesive layer 320 is formed on an inner surface of the electrode part 200 instead of on the first conductive adhesive layer 310 as in the previously described method. The second conductive adhesive layer 320 includes a second conductive paste having a second viscosity. Preferably, the second viscosity is in a range of about 10,000 cps to about 20,000 cps. More preferably, the second viscosity is in a range of about 14,000 cps to about 16,000 cps. The second conductive paste is a mixture including a conductive material, an adhesive, a solvent, etc. The conductive material may include conductive particles such as silver particles. The second conductive paste has a second thickness T2 thicker than the first thickness T1 in this embodiment.

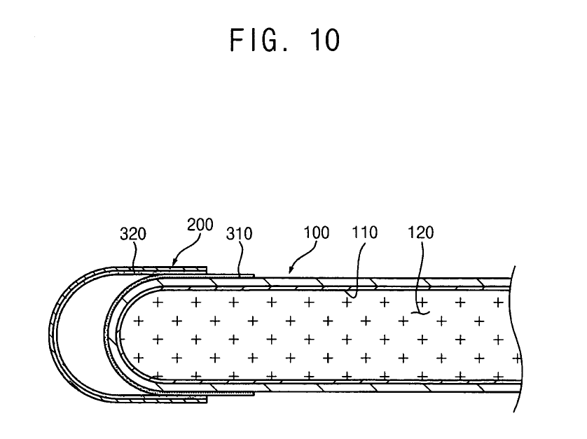

FIG. 10 is a cross-sectional view illustrating coupling of the body 100 and the electrode 200 shown in FIGS. 8 and 9.

Referring to FIG. 10, the electrode part 200 including the second conductive adhesive layer 320 having the second viscosity smaller than the first viscosity formed therein is coupled with the body 100 including the first conductive adhesive layer 310 formed thereon. The electrode part 200 slides onto the first conductive adhesive layer 310, and then the electrode part 200 is disposed over the body 100 with the second conductive adhesive layer 320 disposed over the first conductive adhesive layer 310.

The body 100 including the electrode part 200 coupled therewith is heated. Thus, the solvents of the first and second conductive adhesive layers 310 and 320 are volatilized, so that the electrode part 200 and the body 100 are electrically coupled by the first and second conductive adhesive layers 310 and 320.

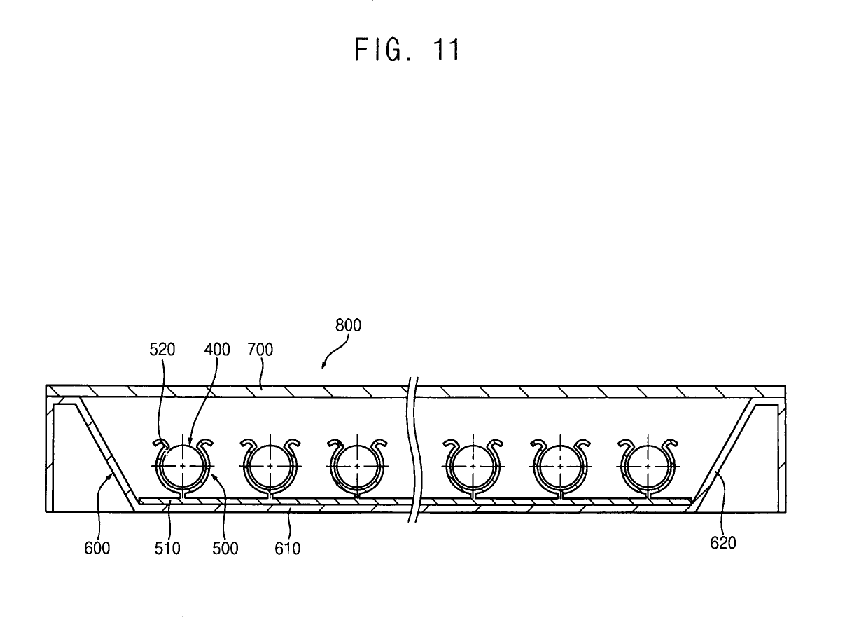

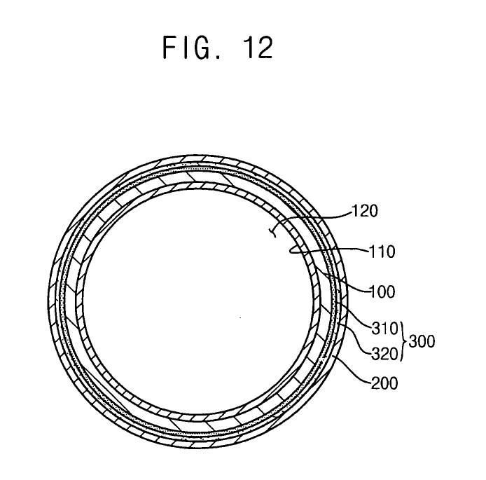

FIG. 11 is a cross-sectional view illustrating an exemplary embodiment of a backlight assembly 800. FIG. 12 is a cross-sectional view illustrating a light generating device 400 in FIG. 11.

Referring to FIGS. 11 and 12, a backlight assembly 800 includes a light generating device 400, a power supplying member 500, and a receiving container 600.

The light generating device 400 includes a body 100, an electrode part 200, and an adhesive member 300.

The body 100, for example, has a cylindrical shape with a circular cross-section. The body 100 includes a material having high optical transmissivity. The body 100 includes, for example, glass, although other materials with similar properties are within the scope of these embodiments. The body 100 may have various profiles such as a linear shape, a curved shape, a U-shape, a C-shape, an L-shape, etc. The body 100 includes a fluorescent layer 110 and a discharge gas 120 to generate visible light.

The fluorescent layer 110 is disposed on an inner surface of the body 100. The fluorescent layer 110 converts invisible light formed in the body 100 into visible light. The fluorescent layer 110, for example, includes red fluorescent material, green fluorescent material, and blue fluorescent material. The red, green, and blue fluorescent materials convert the invisible light into red light, green light, and blue light, respectively. Thus, white light similar to sunlight may be emitted from the fluorescent layer 110.

The discharge gas 120 is injected into the body 100 to generate the invisible light such as UV light. The discharge gas 120, for example, includes mercury (Hg), argon (Ar), neon (Ne), xenon (Xe), krypton (Kr), etc. Mercury generates UV light, and argon, neon, xenon, krypton, etc. generate plasma in the body 100.

The electrode part 200 includes a first electrode 210 and a second electrode 220, such as shown in FIG. 1. The first and second electrodes 210 and 220 are spaced apart from each other on an outer surface of the body 100. For example, first and second electrodes 210, 220 are positioned on first and second end portions of the body 100. When the first and second electrodes 210 and 220 are disposed on the outer surface of the body 100, power consumption of the body 100 may be decreased and at least two light generating devices 100 may be electrically connected substantially in parallel with each other.

A discharging voltage, such as from the power supplying member 500, is applied to the first and second electrodes 210 and 220. Here, the discharging voltage has a voltage sufficient to generate the discharge in the body 100.

The first and second electrodes 210 and 220 may include a metallic material having good electrical conductivity, for example, copper (Cu), copper-alloy, aluminum (Al), aluminum-alloy, etc. Alternatively, the first and second electrodes 210 and 220 may include transparent conductive material, for example, such as indium zinc oxide (“IZO”), indium tin oxide (“ITO”) and amorphous indium tin oxide (“a-ITO”).

In the present embodiment, each of the first and second electrodes 210 and 220 has a cup shape. The first and second electrodes 210 and 220 are coupled with both end portions of the body 100, respectively.

The adhesive member 300 in the illustrated embodiment of FIG. 12 is disposed between each of the first and second electrodes 210 and 220, and body 100. The adhesive member 300 includes a first conductive adhesive layer 310 and a second conductive adhesive layer 320. That is, the adhesive member 300 has a multiple-layered structure.

The first conductive adhesive layer 310 includes a first conductive paste having a first viscosity. The first conductive paste includes a conductive material, an adhesive, and a solvent. Preferably, the first viscosity is in a range of about 20,000 cps to about 30,000 cps, more preferably, in a range of about 24,000 cps to about 26,000 cps.

The conductive material of the first conductive paste, for example, includes metallic particles. The particles may include silver (Ag) particles. Alternatively, the conductive material of the first conductive paste may include gold (Au), copper (Cu), aluminum (Al), etc. having good electrical conductivity.

The adhesive of the first conductive paste, for example, includes an epoxy resin. Alternatively, the adhesive of the first conductive paste may include various synthetic resins.

The second conductive adhesive layer 320 includes a second conductive paste having a second viscosity that is smaller than the first viscosity. The second conductive paste includes a conductive material, an adhesive, and a solvent.

Preferably, the second viscosity is in a range of about 10,000 cps to about 20,000 cps, more preferably, in a range of about 14,000 cps to about 16,000 cps.

The conductive material of the second conductive paste, for example, includes metallic particles. The particles may include silver (Ag) particles. Alternatively, the conductive material of the second conductive paste may include gold (Au), copper (Cu), aluminum (Al), etc. having good electrical conductivity.

The adhesive of the second conductive paste, for example, includes an epoxy resin. Alternatively, the adhesive of the second conductive paste may include various synthetic resins.

In this embodiment, the first viscosity of the first conductive adhesive layer 310 is determined, for example, by weight percent of the solvent among the conductive material, the adhesive and the solvent constituting the first conductive paste.

Also in this embodiment, the second viscosity of the second conductive adhesive layer 320 is determined, for example, by weight percent of the solvent among the conductive material, the adhesive, and the solvent constituting the second conductive paste.

The weight percent of the solvent of the second conductive adhesive layer 320 is greater than that of the first conductive adhesive layer 310. Thus, the second viscosity of the second conductive adhesive layer 320 is smaller than the first viscosity of the first conductive adhesive layer 310.

Since the weight percent of the solvent of the first conductive adhesive layer 310 is lower than that of the second conductive adhesive layer 320, a first thickness T1 of the first conductive adhesive layer 310 is thinner than a second thickness T2 of the second conductive adhesive layer 320.

The electrode part 200 may include an opening. Gas generated when the solvents of the first and second conductive adhesive layers 310 and 320 are volatilized may be exhausted easily through the opening.

The power supplying member 500 supplies the electrode part 200 of the light generating device 400 with a voltage. The power supplying member 500 includes a conductive plate 510 and a clip 520, where a plurality of clips 520 may be distributed across an upper surface of the conductive plate 510 corresponding to a number of light generating devices to be held within the backlight assembly 800.

The conductive plate 510 having, for example, a rectangular parallelepiped shape includes a metallic material. The clip 520 protrudes from the conductive plate 510 and is arranged with other clips 520 to be substantially parallelly disposed on the conductive plate 510 to grip the electrode part 200 of the light generating device 400 to hold a plurality of light generating devices 400 in parallel. The conductive plate 510 is electrically connected with an inverter (not shown) supplying a power that passes through clips 520 to electrode parts 200.

The receiving container 600 includes a bottom plate 610 and a sidewall 620. The power supplying member 500 with which the light generating device 400 is coupled is disposed on the bottom plate 610 of the receiving container 600.

An optical member 700 may be disposed on the sidewall 620 of the receiving container 600 and supported above the light generating devices 400. The optical member 700, for example, includes a light-diffusing plate improving uniformity of a light emitted from the light generating device 400. The optical member 700 may further include a light-diffusing sheet disposed on the light-diffusing plate. Other optical members may also be employed or not included as required for a particular display device.

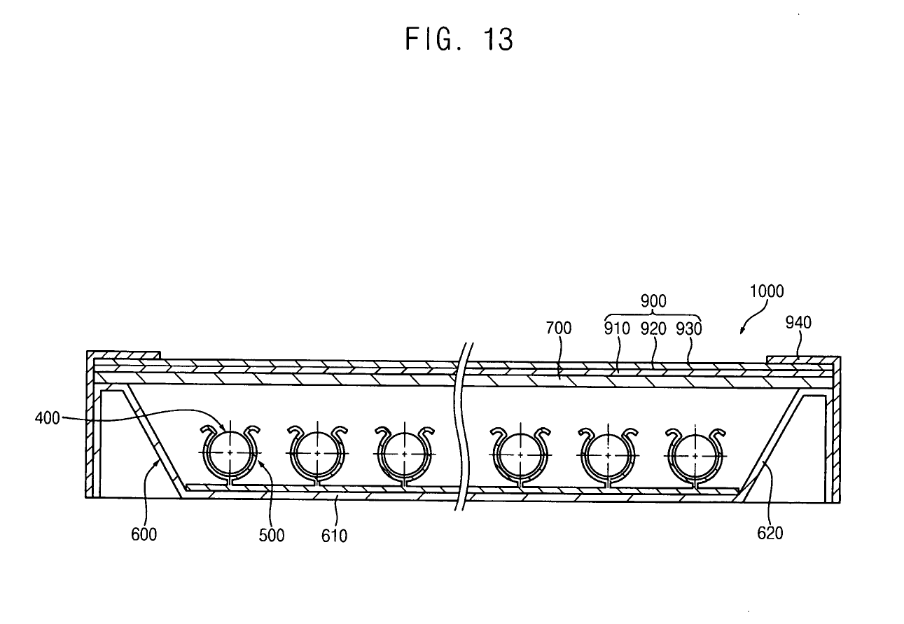

FIG. 13 is a cross-sectional view illustrating an exemplary embodiment of a display device.

Referring to FIG. 13, a display device 1000 includes a backlight assembly 800 and a display panel 900. The display device 1000 may further include a chassis 940.

The backlight assembly 800 of the present embodiment is substantially the same as the backlight assembly illustrated in FIG. 11. Thus, any repetitive description will be omitted.

The display panel 900 includes a thin film transistor (“TFT”) substrate 910, a liquid crystal layer 920, and a color filter substrate 930. The liquid crystal layer 920 is disposed between the TFT substrate 910 and the color filter substrate 930. The display panel 900 may be disposed on the optical member 700 and held in place with respect to the receiving container 600 by the chassis 940.

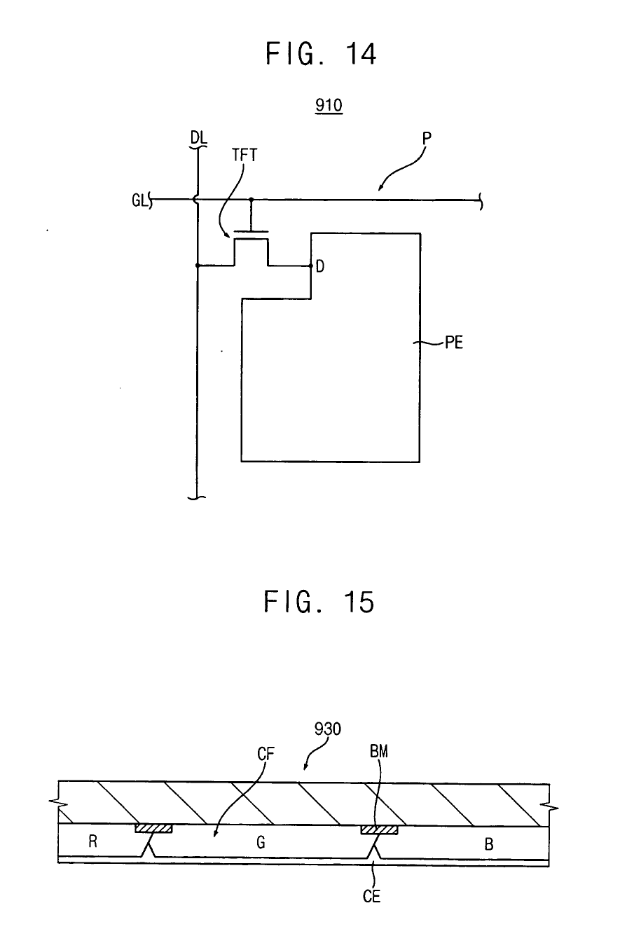

FIG. 14 is a plan view illustrating an exemplary thin film transistor substrate 910 shown in FIG. 13.

Referring to FIG. 14, a TFT substrate 910 includes a plurality of pixels ‘P’. For example, the pixels ‘P’ of 1024×768×3 are disposed on the TFT substrate 910 in a matrix shape when the display device 1000 has a resolution of 1024×768.

Each of the pixels ‘P’ includes a TFT, a gate line GL, a data line DL and a pixel electrode PE. The pixel electrode PE may include a transparent conductive material, such as indium tin oxide (“ITO”), indium zinc oxide (“IZO”), amorphous indium zinc oxide (“a-ITO”), etc.

FIG. 15 is a cross-sectional view illustrating an exemplary color filter substrate 930 shown in FIG. 13.

Referring to FIG. 15, the color filter substrate 930 is disposed such that the color filter substrate 930 faces the TFT substrate 910 with the liquid crystal layer 920 disposed between the TFT substrate 910 and the color filter substrate 930. The color filter substrate 930 includes a color filter CF, a black matrix BM, and a common electrode CE. The common electrode CE may include a transparent conductive material, such as indium tin oxide (“ITO”), indium zinc oxide (“IZO”), amorphous indium zinc oxide (“a-ITO”), etc.

The color filter CF is disposed such that the color filter CF faces the pixel electrode PE of the TFT substrate 910. For example, the color filters CF of 1024×768×3 are disposed on the color filter substrate 930 when the display device 1000 has a resolution of 1024×768.

According to the above described embodiments, an adhesive member having, for example, double layers of a different viscosity from each other is formed between a body and an electrode of a light generating device generating a light to display an image, thereby restraining a void between the body and the electrode, so that an efficiency of the light generating device is increased and display quality of the image is improved.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A light generating device comprising:
a body generating visible light;
an electrode disposed on the body to apply a power to the body; and
an adhesive member including a first conductive adhesive layer formed between the body and the electrode and having a first conductive paste of a first viscosity, and a second conductive adhesive layer formed between the electrode and the first conductive adhesive layer and having a second conductive paste of a second viscosity that is different from the first viscosity.

2. The light generating device of claim 1, wherein the second viscosity is smaller than the first viscosity.

3. The light generating device of claim 1, wherein the first conductive paste includes a conductive material, an adhesive, and a solvent.

4. The light generating device of claim 1, wherein the second conductive paste includes a conductive material, an adhesive, and a solvent.

5. The light generating device of claim 1, wherein the first and second conductive pastes each include a conductive material, an adhesive, and a solvent, and a weight percent of the solvent of the second conductive paste is greater than a weight percent of the solvent of the first conductive paste.

6. The light generating device of claim 1, wherein the adhesive member includes silver.

7. The light generating device of claim 1, wherein the first viscosity is in a range of about 20,000 cps to about 30,000 cps.

8. The light generating device of claim 7, wherein the first viscosity is in a range of about 24,000 cps to about 26,000 cps.

9. The light generating device of claim 1, wherein the second viscosity is in a range of about 10,000 cps to about 20,000 cps.

10. The light generating device of claim 9, wherein the second viscosity is in a range of about 14,000 cps to about 16,000 cps.

11. The light generating device of claim 1, further comprising:
a discharge gas introduced in the body to generate invisible light by discharge; and
a fluorescent layer disposed on an inner surface of the body to convert the invisible light into the visible light.

12. The light generating device of claim 1, wherein the second conductive adhesive layer protects the first conductive adhesive layer when the electrode is disposed on the body and prevents a void from generating between the body and the electrode.

13. The light generating device of claim 1, wherein a thickness of the first conductive adhesive layer is less than a thickness of the second conductive adhesive layer.

14. A method of manufacturing a light generating device, comprising:
forming a body converting invisible light into visible light;
forming a first conductive adhesive layer having a first conductive paste of a first viscosity on at least one end portion of the body;
forming a second conductive adhesive layer having a second conductive paste of a second viscosity on the first conductive adhesive layer, the second viscosity being different from the first viscosity; and
forming electrodes applying power to the body on the second conductive adhesive layer.

15. The method of claim 14, wherein the second viscosity is smaller than the first viscosity.

16. The method of claim 14, wherein the body is formed by:
forming a fluorescent layer on an inner surface of the body; and
injecting discharge gas into the body.

17. The method of claim 14, wherein the first viscosity is in a range of about 20,000 cps to about 30,000 cps.

18. The method of claim 14, wherein the second viscosity is in a range of about 10,000 cps to about 20,000 cps.

19. The method of claim 14, further comprising heating the body and electrodes to volatize solvents of the first and second conductive adhesive layers.

20. The method of claim 19, further comprising releasing gas generated when the solvents are volatized through an opening in the electrodes.

21. The method of claim 14, further comprising forming a first thickness of the first conductive paste, and forming a second thickness of the second conductive paste, the first thickness being less than the second thickness.

22. A method of manufacturing a light generating device, comprising:
forming a body converting invisible light into visible light;
forming a first conductive adhesive layer having a first conductive paste of a first viscosity on at least one end portion of the body;
forming a second conductive adhesive layer having a second conductive paste of a second viscosity that is different from the first viscosity of the first conductive adhesive on an inner surface of an electrode; and
coupling the electrode with the body so that the second conductive adhesive layer is disposed on the first conductive adhesive layer.

23. The method of claim 22, wherein the second viscosity is smaller than the first viscosity.

24. The method of claim 22, wherein the first viscosity is in a range of about 20,000 cps to about 30,000 cps.

25. The method of claim 22, wherein the second viscosity is in a range of about 10,000 cps to about 20,000 cps.

26. The method of claim 22, further comprising heating the body and electrode to volatize solvents within the first and second conductive adhesive layers.

27. The method of claim 22, further comprising forming a first thickness of the first conductive paste, and forming a second thickness of the second conductive paste, the first thickness being less than the second thickness.

28. A backlight assembly comprising:
a light generating device comprising:
a lamp body converting invisible light into visible light;
a plurality of electrodes disposed on the lamp body to apply power to the lamp body; and
an adhesive member including a first conductive adhesive layer formed between the lamp body and each of the electrodes and a second conductive adhesive layer formed between the first conductive adhesive layer and each of the electrodes, the first conductive adhesive layer having a first conductive paste of a first viscosity and the second conductive adhesive layer having a second conductive paste of a second viscosity that is different from the first viscosity;
a power supplying member supplying the electrodes with power; and
a receiving container including a bottom plate and a sidewall disposed on the bottom plate to form a receiving space receiving the light generating device and the power supplying member.

29. The backlight assembly of claim 28, wherein the second viscosity is smaller than the first viscosity.

30. The backlight assembly of claim 28, wherein the power supplying member is electrically coupled with a plurality of light generating devices that are electrically and substantially parallelly connected to each other.

31. The backlight assembly of claim 28, further comprising an optical member disposed over the receiving container to improve optical characteristics of the visible light emitted from the light generating device.

32. The backlight assembly of claim 31, wherein the optical member includes a light-diffusing plate disposed on the sidewall.

33. The backlight assembly of claim 28, wherein the first viscosity is in a range of about 20,000 cps to about 30,000 cps.

34. The backlight assembly of claim 28, wherein the second viscosity is in a range of about 10,000 cps to about 20,000 cps.

35. The backlight assembly of claim 28, wherein the second conductive adhesive layer protects the first conductive adhesive layer when the electrode is disposed on the body and prevents a void from generating between the body and the electrode.

36. The backlight assembly of claim 28, wherein a thickness of the first conductive adhesive layer is less than a thickness of the second conductive adhesive layer.

37. A display device comprising:
a light generating device comprising:
a lamp body converting invisible light into visible light;
a plurality of electrodes disposed on the lamp body to apply power to the lamp body; and
an adhesive member including a first conductive adhesive layer formed between the lamp body and each of the electrodes and a second conductive adhesive layer formed between the first conductive adhesive layer and each of the electrodes, the first conductive adhesive layer having a first conductive paste of a first viscosity and the second conductive adhesive layer having a second conductive paste of a second viscosity that is different from the first viscosity;
a power supplying member supplying the electrodes with power;
a receiving container including a bottom plate and a sidewall disposed on the bottom plate to form a receiving space receiving the light generating device and the power supplying member; and
a display panel disposed over the receiving container to convert the visible light into light having an image information.

38. The display device of claim 37, wherein the second viscosity is smaller than the first viscosity.
